(19) United States
(12) Patent Application Publication
(10) Pub. No.: US 2015/0269110 A1
(43) Pub. Date: Sep. 24, 2015

(54) CABLE WITH MULTIPLE FUNCTIONS

(71) Applicant: Shanghai Bplus Electronics Technology LTD., Shanghai (CN)

(72) Inventor: CHIA-YU CHEN, New Taipei (TW)

(21) Appl. No.: 14/733,329

(22) Filed: Jun. 8, 2015

Related U.S. Application Data
(63) Continuation-in-part of application No. PCT/CN2014/078916, filed on May 30, 2014.

(30) Foreign Application Priority Data
Jun. 19, 2013 (CN) 201310245090.6

(51) Int. Cl. G06F 13/42; G06F 13/40

(52) U.S. Cl. CPC G06F 13/4221; G06F 13/4068; G06F 13/4022

(57) ABSTRACT

A cable for establishing different communications between the cable, a first external device, and a second external device. The cable includes a first connector, a second connector, a controlling unit, a switching unit, a rectification unit, and a storage unit. The controlling unit generates different controlling signals to the switching unit based on a bus power from the first external device and an identification signal from the second external device. The rectification unit ensures a current direction from the first external device to the second connector when the bus power is supplied. In a first function, the switching unit establishes a communication between the first external device and the second external device; in a second function, the switching unit establishes a communication between the first external device and the cable, and in a third function, the switching unit establishes a communication between the second external device and the cable.

### CROSS-REFERENCE TO RELATED APPLICATIONS

This application is a continuation-in-part of and claims the benefit of priority from PCT Application serial No. PCT/CN2014/078916, filed on May 30, 2014, entitled, “A SWITCHING CABLE WITH MULTIPLE FUNCTIONS,” accruing under 35 U.S.C. §119.

### FIELD

The subject matter herein generally relates to a cable with multiple functions, and more particularly, to a switchable cable with multiple functions.

### BACKGROUND

Standards of interface for a personal computer and a tablet are different. As shown in FIG. 14 the personal computer supports a type-A USB standard interface, and the tablet supports a type-B microUSB standard interface. A memory card using a specific USB interface only supports a standard corresponding to the personal computer or the tablet. For example, the USB flash drive supporting to the type-A USB standard is unable to directly communicate to the tablet supporting type-B microUSB standard, therefore, an On-The-Go (OTG) cable is needed for establishing a communication between the tablet and the USB flash drive. In addition, the OTG cable is unable to directly establish a communication between the personal computer and the tablet for transmitting data or charging, so that a USB-microUSB cable is needed for establishing a communication between the personal computer and the tablet. Therefore, these three different cables and devices are required for transmitting data between the personal computer and the tablet, a USB flash drive supporting type-A USB standard, a USB flash drive supporting type-B microUSB standard, and the OTG cable are needed.

### BRIEF DESCRIPTION OF THE FIGURES

Implementations of the present technology will now be described, by way of example only, with reference to the attached figures.

FIG. 1 is a diagrammatic view of an embodiment of a cable.

FIG. 2 is a diagrammatic view of a second embodiment of a cable.

FIG. 3 is a diagrammatic view of a third embodiment of a cable.

FIG. 4 is a diagrammatic view of a fourth embodiment of a cable.

FIGS. 5-8 are a flowchart of a switching method.

FIG. 9 is a diagrammatic view of a fifth embodiment of a cable.

FIG. 10 is a diagrammatic view of a sixth embodiment of a cable.

FIG. 11 is a diagrammatic view of a seventh embodiment of a cable.

FIG. 12 is a diagrammatic view of an eighth embodiment of a cable.

FIG. 13 is a diagrammatic view of a ninth embodiment of a cable.

FIG. 14 is a diagrammatic view of a cable in a related art.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

The term “comprising” means “including, but not necessarily limited to”; it specifically indicates open-ended inclusion or membership in a so-described combination, group, series and the like.

The present disclosure is described in relation to a cable with multiple functions.

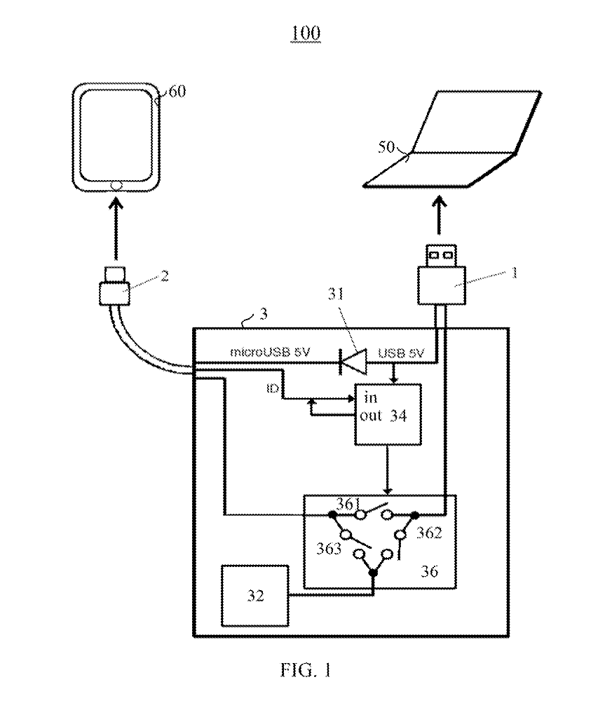

FIG. 1 illustrates an embodiment of a cable 100 for connecting a first external device 50 with an interface in a first standard and a second external device 60 with an interface in a second standard. The cable 100 is capable of switching functions. The functions include a first function for establishing communication between the first external device 50 and the second external device 60, a second function for establishing a communication between the first external device 50 and the cable 100, and a third function for establishing a communication between the second external device 60 and the cable 100. In the first function, the first external device 50 acts as a host, and the second external device 60 further stops outputting a bus power and receives the bus power from the first external device 50. In the second function and the third function, the cable 100 works as an external storage connected with the first external device 50 or the second external device 60 for communicating data. In at least one embodiment, the first external device 50 is a personal computer and the second external device 60 is a tablet.

The cable 100 includes a first connector 1 for connecting with the first external device 50, a second connector 2 for connecting with the second external device 60, and a switching module 3 connected between the first connector 1 and the second connector 2. In at least one embodiment, the first connector 1 and the second connector 2 supports USB2.0 standard.

The switching module 3 is capable of switching between different modes based on the bus power from the first external device 50 and an identification signal ID obtained from the second connector 2. The identification signal ID is obtained from an ID pin (not shown) of the second connector 2, not only denotes whether the second external device 60 is connected with the second connector 2, but also denotes the second external device 60 serves as a host. The identification signal ID can be set in a logic low level signal or a logic high level signal. In detail, when the first external device 50 is connected to the first connector 1, and the second external device 60 is connected to the second connector 2, which causing the identification signal ID to be set in a logic high level signal by an internal pull-up resistor in the second external device 60. When the first external device 50 is connected to the first connector 1, and the second external device 60 is disconnected to the second connector 2, which causing the identification signal ID in the second connector 2 is set in the logic low level signal. When the first external device 50 is disconnected and no bus power is supplied from the first connector 1, the switching module 3 outputs a logic low level signal to the second connector 2, which causing the second external device 60 connected to the second connector 2 to be served as the host.

The switching module 3 includes a rectification unit 31, a storage unit 32, a controlling unit 34, and a switching unit 36.

The rectification unit 31 is applied to a power bus line of the cable 100 and is connected between the first connector 1 and the second connector 2. When both the first external device 50 and the second external device 60 are connected to the switching module 3, the rectification unit 31 is configured to ensure a current direction on the power bus line is from the first external device 50 to the second connector 2. In the embodiment, a diode circuit is provided to the rectification unit 31 for ensuring the current following from the first external device 50 to the second external device 60, so as to ensure the first external device 50 acts as the host. It is contemplated that the rectification unit 31 may be a metal-oxide-semiconductor (MOS) switch or a diode as well.

The storage unit 32 is capable of communicating data with the first external device 50 when the cable 100 is in the second function, and communicating data with the second external device 60 when the cable 100 is in the third function. In such cases, the storage unit 32 can be a memory of the cable 100.

The controlling unit 34 includes an input pin IN and an output pin OUT. The input pin IN is connected to the second connector 2 for receiving identification signal ID. The output pin OUT is connected between the second connector 2 and the input pin IN. The controlling unit 34 detects whether the bus power is supplied from the first external device 50 for setting a state of the output pin OUT. The controlling unit 34 further generates different controlling signals to the switching unit 36 based on the bus power from the first external device 50 and the identification signal ID. When the bus power is supplied from the first external device 50 and the second external device 60 is connected with the second connector 2, which means the first external device 50 serves as the host. The controlling unit 34 sets the output pin OUT in an OPEN state for stopping outputting the logic low level signal to the second connector 2. The controlling unit 34 further generates a first controlling signal to the switching unit 36. When the bus power is supplied from the first external device 50 and the second external device 60 is disconnected with the second connector 2, the controlling unit 34 remains setting the output pin OUT in the OPEN state for stopping outputting the logic low level signal to the second connector 2. The controlling unit 34 further generates a second controlling signal to the switching unit 36 When no bus power from the first external device 50 is received and the second external device 60 connects with the second connector 2, which means the second external device 60 acts as the host, the controlling unit 34 sets the output pin OUT in the GND state for outputting a logic low level signal. The controlling unit 34 further generates a third controlling signal to the switching unit 36. In at least one embodiment, the output pin OUT of the controlling unit 34 can be a mechanical relay switch for outputting GND state without the bus power from the first external device 50.

The switching unit 36 includes a first switch 361, a second switch 362, and a third switch 363. The first switch 361 is connected between the first connector 1 and the second connector 2. The second switch 362 is connected between the first connector 1 and the storage unit 32. The third switch 363 is connected between the second connector 2 and the storage unit 32. The first switch 361 turns on for establishing the communication between the first external device 50 and the second external device 60 in response to the first controlling signal. The second switch 362 turns on for establishing the communication between the first external device 50 and the cable 100 in response to the second controlling signal. The third switch 363 turns on for establishing the communication between the second external device 60 and the cable 100 in response to the third controlling signal.

Table 1, below, shows the relationship between the identification signal ID, the bus power from the first external device 50, the turn-on switch of the switching unit 36, and the function of the cable 100 for establishing communication.

TABLE 1

| Condition | | | | |
|---|---|---|---|---|
| Bus power | | Result | | |
| from the first | | Turn-on | Function of the | State of the |
| external device | ID Signal | switch | cable | output pin |
| 5 V | HIGH | 361 | USB-microUSB | OPEN |
| | | | cable | |
| 5 V | LOW | 362 | USB-storage unit | OPEN |
| 0 V | X | 363 | microUSB-storage | GND |
| | | | unit | |

When the bus power from the first external device 50 is received, and the second external device 60 is connected with the second connector 2, the identification signal ID is set in a logic high level signal by an internal pull-up resistor in the second external device 60, and the output pin OUT is in the OPEN state. The controlling unit 34 generates the first controlling signal to the switching unit 36, and the controlling unit 34 controls the first switch 361 to turn on for establishing the communication between the first external device 50 and the second external device 60, thus the cable 100 switches into the first function and the second external device 60 stops outputting the bus power. When the bus power from the first external device 50 is received, and the second external device 60 disconnects with the second connector 2, the identification signal ID is set in the logic lower level signal, and the output pin OUT is in the OPEN state. The controlling unit 34 generates the second controlling signal to the switching unit 36, the controlling unit 34 controls the second switch 362 to turn on for establishing the communication between the first external device 50 and the storage unit 32, thus the cable 100 switches into the second function. When the first external device 50 is disconnected to the first connector 1, and no bus power from the first external device 50 is received and the second external device 60 connects with the second connector 2, which means the second external device 60 to be acted as the host, the output pin OUT is in the GND state and the controlling unit 34 generates the third controlling signal to the switching unit 36, the controlling unit 34 controls the third switch 363 to turn on for establishing the communication between the second external device 60 and the storage unit 32, thus the cable 100 switches into the third function and the second external device 60 outputs the bus power.

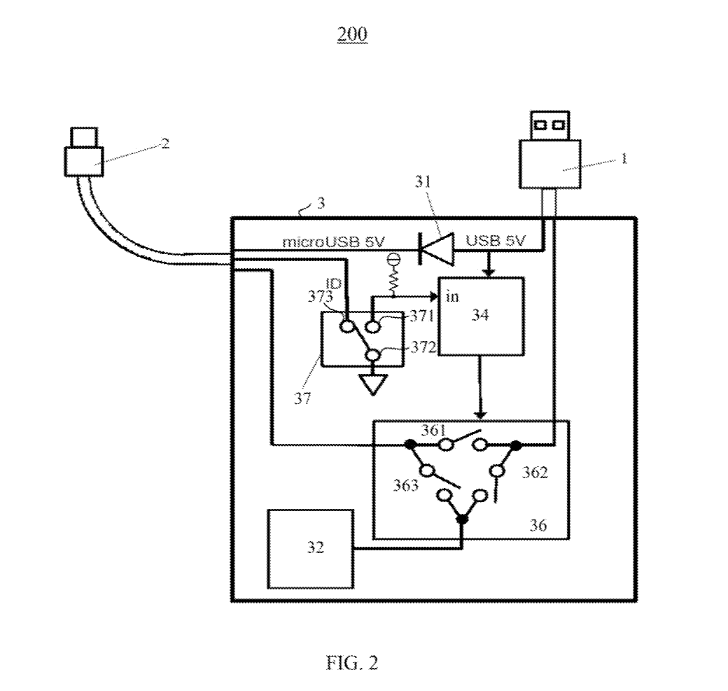

FIG. 2 illustrates a second embodiment of the cable 200. The cable 200 further includes a manual-operation switch 37. The manual operation switch 37 is connected between the ID pin of the second connector 2 and the controlling unit 34. The manual-operation switch 37 is capable of switching between two switching modes via user operations to set the states of the input pin IN. When in a first switching mode, the manual-operation switch 37 sets the input pin IN of the controlling unit 34 in an OPEN state. When in a second switching mode, the manual-operation switch 37 sets the input pin IN of the controlling unit 34 in a GND state. The controlling unit 34 generates different controlling signals based on the bus power from the first external device 50 (as shown in FIG. 1) and the state of the input pin IN of the controlling unit 34 set by the manual-operation switch 37. In the embodiment, the manual-operation switch 37 is a signal-pole double throw switch.

The manual-operation switch 37 includes a first pin 371, a second pin 372, and a third pin 373. The first pin 371 is connected to the input pin IN of the controlling unit 34. The second pin 372 is grounded. The third pin 373 is connected to the ID pin of the second connector 2. In the first switching mode, the second pin 372 connects with the first pin 371 for setting the input pin IN of the controlling unit 34 in the OPEN state, which means the first external device 50 acts as the host. In the second switching mode, the second pin 372 connects with the third pin 373 for setting the input pin In of the controlling unit 34 in the GND state, which means the second external device 60 acts as the host.

When the first external device 50 is connected to the first connector 1, and the manual-operation switch 37 is switched to the first switching mode for connecting the second pin 372 with the first pin 371. That is, the input pin In is set in the OPEN state, and the controlling unit 34 outputs a first controlling signal to the switching unit 36. The switching unit 36 switches the cable 200 into the first mode for establishing the communication between the first external device 50 and the second external device 60.

When the first external device 50 is disconnected to the first connector 1, and the manual-operation switch 37 is switched to the first switching mode for connecting the second pin 372 with the first pin 371. That is, the input pin In is set in the OPEN state, and the controlling unit 34 stops outputting any controlling signals to the switching unit 36. The switching unit 36 is disable for controlling the cable 200 to be disabled.

When first external device 50 is connected to the first connector 1, and the manual-operation switch 37 is switched to the second switching mode for connecting the second pin 372 with the third pin 373. That is, the input pin IN is set in the GND state, and the controlling unit 34 outputs a second controlling signal to the switching unit 36. The switching unit 36 switches the cable 200 into the second mode for establishing the communication between the first external device 50 and the cable 200, for example, the storage unit 32.

When the first external device 50 is disconnected with the first connector 1, and the manual-operation switch 37 is switched to the second switching mode for connecting the second pin 372 with the third pin 373. That is, the input pin IN is set in the OPEN state, and the controlling unit 34 outputs a third controlling signal to the switching unit 36. The switching unit 36 switches the cable 200 into the third mode for establishing the communication between the second external device 60 and the cable 200, for example, the storage unit 32.

Table 2 below shows the relationship between the switching mode of the manual-operation switch 37, the bus power from the first external device 50, the states of the identification signal ID, the turn-on switch of the switching unit 36, and the function of the cable 200 for establishing communication.

TABLE 2

| Condition | | | | |
|---|---|---|---|---|
| Bus power | | Result | | |
| from the first | Switching | State of the | Turn-on | Function of the |
| external device | mode | input pin | switch | cable |
| 5 V | 371-372 | OPEN | 361 | USB-microUSB |
| | | | | cable |
| 0 V | 371-372 | OPEN | N/A | N/A |
| 5 V | 372-373 | GND | 362 | USB-storage unit |
| 0 V | 372-373 | GND | 363 | microUSB-storage |
| | | | | unit |

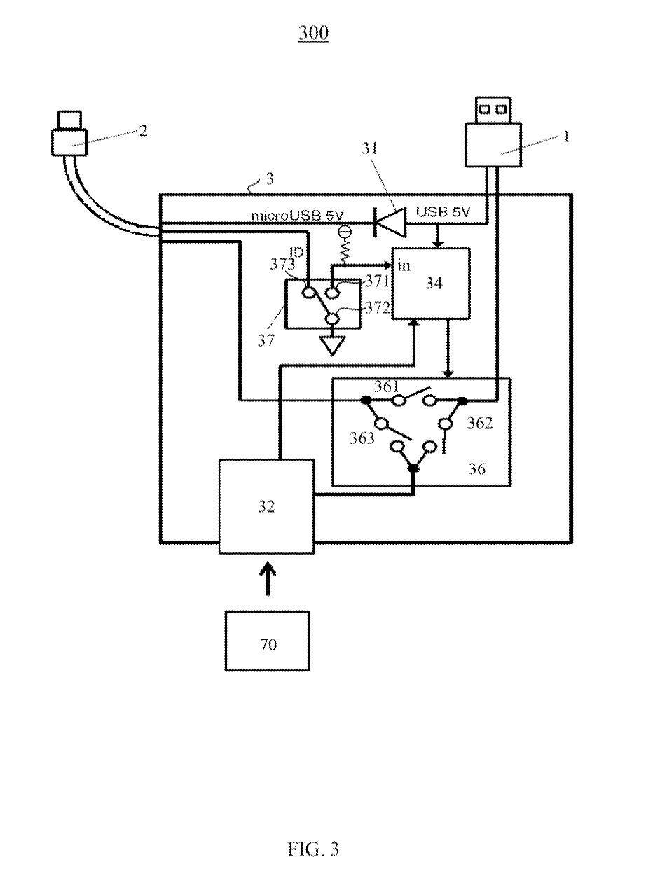

FIG. 3 illustrates a third embodiment of the cable 300. The difference between the cable 300 and the cable 200 is the storage unit 32 and the controlling unit 34. The storage unit 32 is capable of connecting with an external storage 70. The storage unit 32 determines whether the storage unit 32 connects with the external storage 70. When the storage unit 32 connects with the external storage 70, the storage unit 32 generates a detecting signal to the controlling unit 34. The controlling unit 34 generates different controlling signals based on the bus power from the first external device 50, the switching mode of the manual-operation switch 37, and the detecting signal generated by the storage unit 32.

Table 3 below shows the relationship between the bus power from the first external device 50, the switching mode of the manual-operation switch 37, the detecting signal from the storage unit 32, the turn-on switch of the switching unit 36, and the function of the cable 300 for establishing communication.

TABLE 3

| Condition | | | Result | | |
|---|---|---|---|---|---|
| Bus power | Switch- | Detect- | Turn- | | |
| from the first | ing | ing | on | ID | Function of the |
| external device | mode | signal | switch | State | cable |
| 5 V | 371-372 | X | 361 | OPEN | USB-microUSB |
| | | | | | cable |
| 5 V | 372-373 | Y | 362 | GND | USB-storage unit |
| 0 V | 371-372 | Y | N/A | OPEN | N/A |
| 0 V | 372-373 | Y | 363 | GND | microUSB- |
| | | | | | storage unit |

When the bus power from the first external device 50 is received which means the first external device 50 acts as the host, the manual-operation switch 37 is in the first switching mode for connecting the first pin 371 with the second pin 372, and no matter whether the controlling unit 34 receives the detecting signal from the storage unit 32, the input pin IN of the controlling unit 34 is set in the OPEN state, and the controlling unit 34 generates a first controlling signal for controlling the first switch 361 to turn on, therefore the cable 300 switches into the first function for establishing the communication between the first external device 50 and the second external device 60. When the bus power from the first external device 50 is received, the manual-operation switch 37 is in the second switching mode for connecting the third pin 373 with the second pin 372, and the controlling unit 34 receives the detecting signal from the storage unit 32, the input pin IN of the controlling unit 34 is set in the GND state, and the controlling unit 34 generates a first controlling signal for controlling the second switch 362 to turn on, therefore the cable 300 switches into the second function for establishing the communication between the first external device 50 and the storage unit 32. When no bus power from the first external device 50 is received, the manual-operation switch 37 is in the second switching mode for connecting the third pin 373 with the second pin 372, and the controlling unit 34 receives the detecting signal from the storage unit 32, the second external device 60 acts as the host, the input pin IN of the controlling unit 34 is set in the GND state, and the controlling unit 34 generates a third controlling signal for controlling the third switch 363 to turn on, therefore the cable 300 switches into the third function for establishing the communication between the second external device 60 and the storage unit 32.

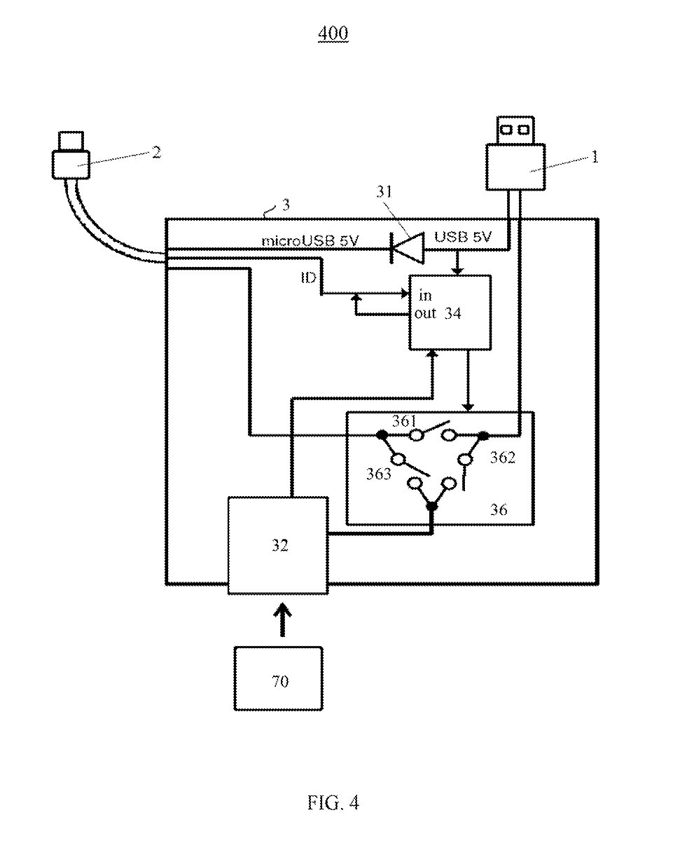

FIG. 4 illustrates a fourth embodiment of the cable 400. The difference between the cable 400 and the cable 100 is the storage unit 32 and the controlling unit 34. The storage unit 32 is a connector for connecting with an external storage 70. The storage unit 32 determines whether the storage unit 32 connects with the external storage 70. When the storage unit 32 connects with the external storage 70, the storage unit 32 generates a detecting signal to the controlling unit 34. The controlling unit 34 generates different controlling signals based on the bus power from the first external device 50, the identification signal ID from the second external device 60, and the detecting signal generated by the storage unit 32. In the embodiment, the storage unit 32 includes a memory card slot, and the external storage 70 can be for example a portable memory card connected with the memory card slot of the storage unit 32.

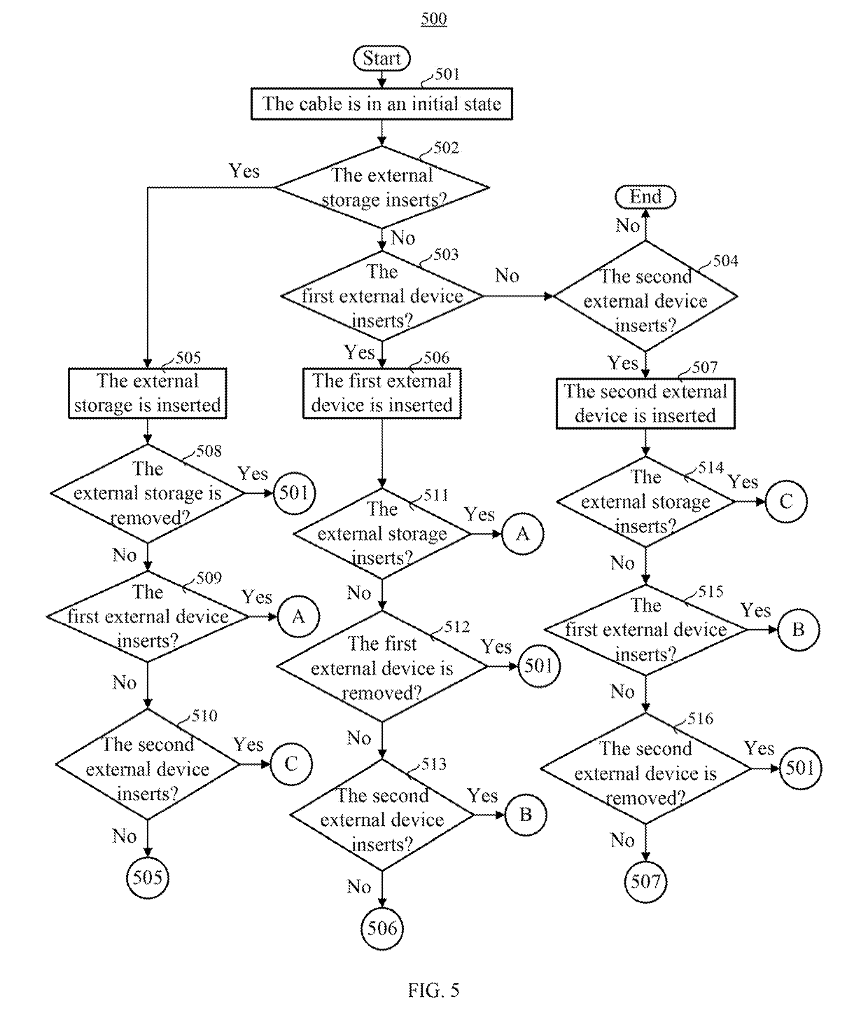

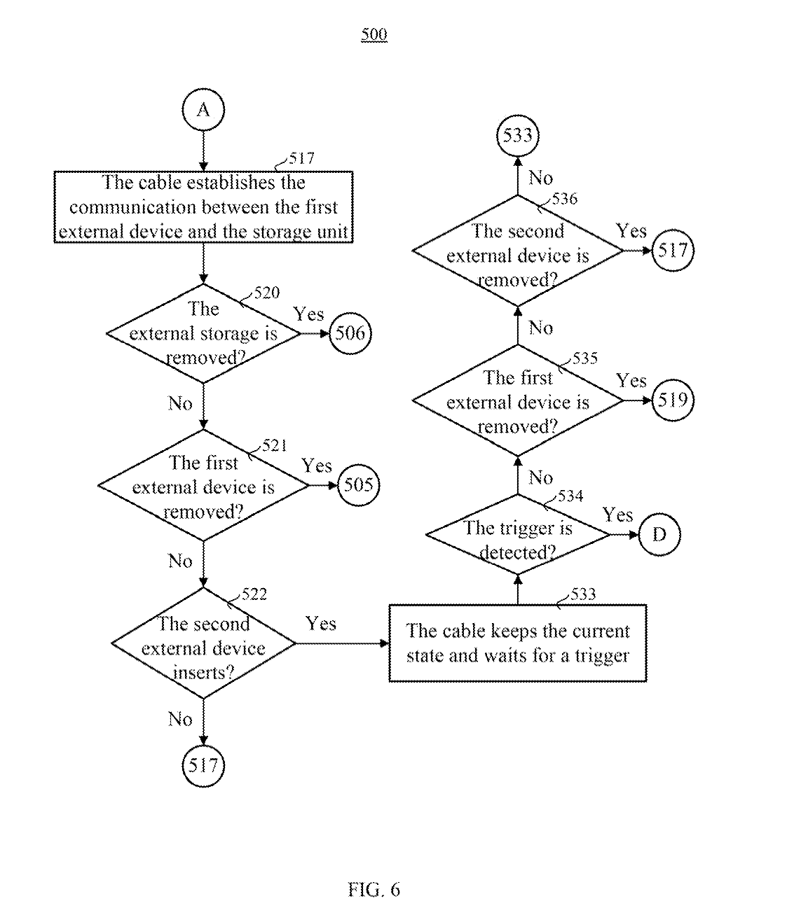

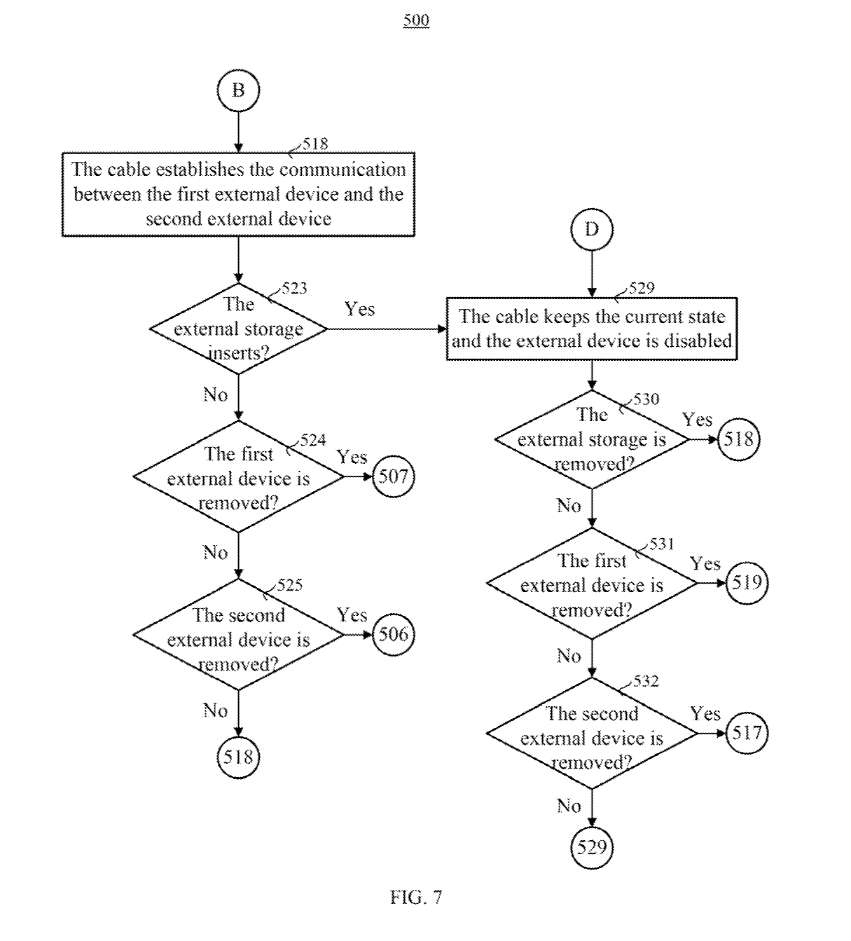

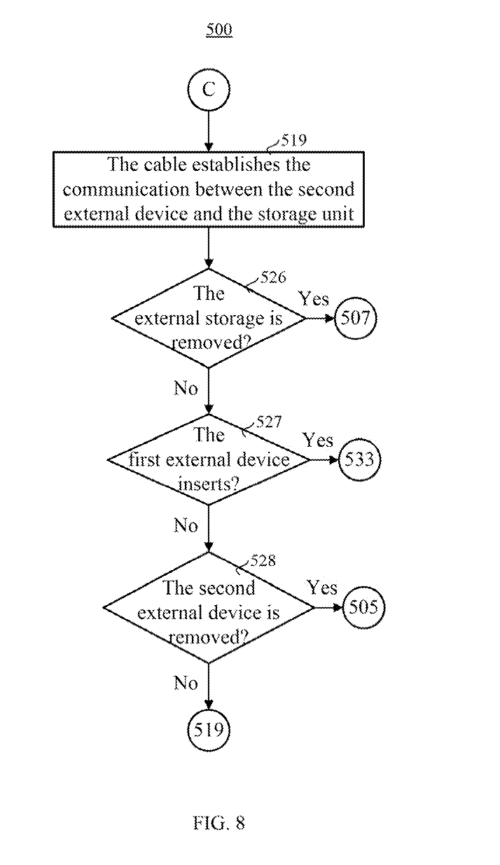

FIGS. 5-8 illustrate a flowchart presented in accordance with an example embodiment. The method 500 is provided by way of example, as there are a variety of ways to carry out the method. The method 500 described below can be carried out using the configurations illustrated in FIG. 4, for example, and various elements of these figures are referenced in explaining the method 500. Each block shown in FIGS. 5-6 represents one or more processes, methods, or subroutines carried out in the method 500. Furthermore, the order of blocks is illustrative only and the order of the blocks can change. Additional blocks can be added or blocks can be removed, without departing from this disclosure. The method 500 can begin at block 501.

At block 501, the cable 400 is in an initial state. In at least one embodiment, the cable 400 disconnects with the first external device 50, the second external device 60, and the external storage 70.

At block 502, the cable 400 detects whether the external storage 70 inserts into the cable 400. When the external storage 70 inserts into the cable 400, the procedure goes to block 503. When the external storage 70 does not insert into the cable 100, the procedure goes to block 514.

At block 503, the cable 400 detects whether the first external device 50 inserts into the cable 400. When the first external device 50 inserts into the cable 400, the procedure goes to block 506. When the first external device 50 does not insert into the cable 400, the procedure goes to block 504.

At block 504, the cable 400 detects whether the second external device 60 inserts into the cable 400. When the second external device 60 inserts into the cable 400, the procedure goes to block 507. When the second external device 60 does not insert into the cable 400, the procedure goes to block 501.

At block 505, the external storage 70 is inserted into the cable 400 merely. Meanwhile, the cable 400 is disconnected with the first external device 50 and the second external device 60.

At block 506, the first external device 50 is inserted into the cable 400 merely. Meanwhile, the cable 400 are disconnected with the external storage 70 and the second external device 60.

At block 507, the second external device 60 is inserted into the cable 400 merely. Meanwhile, the cable 400 is disconnected with the external storage 70 and the first external device 50.

At block 508, the cable 400 detects whether the external storage 70 removes from the cable 400. When the external storage 70 removes from the cable 400, the procedure goes to block 501. When the external storage 70 does not remove from the cable 400, the procedure goes to block 509.

At block 509, the cable 400 detects whether the first external device 50 inserts into the cable 400. When the first external device 50 inserts into the cable 400, the procedure goes to block 517. When the first external device 50 does not insert into the cable 400, the procedure goes to block 510.

At block 510, the cable 400 detects whether the second external device 60 inserts into the cable 400. When the second external device 60 inserts into the cable 400, the procedure goes to block 519. When the second external device 60 does not insert into the cable 400, the procedure goes to block 505.

At block 511, the cable 400 detects whether the external storage 70 inserts into the cable 400. When the external storage 70 inserts into the cable 400, the procedure goes to block 517. When the external storage 70 does not insert into the cable 400, the procedure goes to block 512.

At block 512, the cable 400 detects whether the first external device 50 removes from the cable 400. When the first external device 50 removes from the cable 400, the procedure goes to block 501. When the first external device 50 does not remove from the cable 400, the procedure goes to block 513.

At block 513, the cable 400 detects whether the second external device 60 inserts into the cable 400. When the second external device 60 inserts into the cable 400, the procedure goes to block 518. When the second external device 60 does not insert into the cable 400, the procedure goes to block 506.

At block 514, the cable 400 detects whether the external storage 70 inserts into the cable 400. When the external storage 70 inserts into the cable 400, the procedure goes to block 519. When the external storage 70 does not insert into the cable 400, the procedure goes to block 515.

At block 515, the cable 400 detects whether the first external device 50 inserts into the cable 400. When the first external device 50 inserts into the cable 400, the procedure goes to block 518. When the first external device 50 does not insert into the cable 400, the procedure goes to block 516.

At block 516, the cable 400 detects whether the second external device 60 removes from the cable 400. When the second external device 60 removes from the cable 400, the procedure goes to block 501. When the second external device 60 does not remove from the cable 400, the procedure goes to block 507.

At block 517, the cable 400 in the second function establishes the communication between the first external device 50 and the external storage 70. At present, the cable 400 is simultaneously connected with the first external device 50 and the external storage 70, and is disconnected with the second external device 60.

At block 518, the cable 400 in the first function establishes communication between the first external device 50 and the second external device 60. At present, the cable 400 is simultaneously connected with the first external device 50 and the second external device 60, and is disconnected with the external storage 70.

At block 519, cable 400 in the third function establishes communication between the second external device 60 and the external storage 70. At present, the cable 400 is simultaneously connected with the second external device 60 and the external storage 70, and is disconnected with the first external device 50.

At block 520, the cable 400 detects whether the external storage 70 removes from the cable 400. When the external storage 70 removes from the cable 400, the procedure goes to block 506. When the external storage 70 does not remove from the cable 400, the procedure goes to block 521.

At block 521, the cable 400 detects whether the first external device 50 removes from the cable 400. When the first external device 50 removes from the cable 400, the procedure goes to block 505. When the first external device 50 does not remove from the cable 400, the procedure goes to block 522.

At block 522, the cable 400 detects whether the second external device 60 inserts into the cable 400. When the second external device 60 inserts into the cable 400, the procedure goes to block 533. When the second external device 60 does not insert into the cable 400, the procedure goes to block 517.

At block 523, the cable 400 detects whether the external storage 70 inserts into the cable 400. When the external storage 70 inserts into the cable 400, the procedure goes to block 529. When the external storage 70 does not insert into the cable 400, the procedure goes to block 524.

At block 524, the cable 400 detects whether the first external device 50 removes from the cable 400. When the first external device 50 removes from the cable 400, the procedure goes to block 507. When the first external device 50 does not remove from the cable 400, the procedure goes to block 525.

At block 525, the cable 400 detects whether the second external device 60 removes from the cable 400. When the second external device 60 removes from the cable 400, the procedure goes to block 506. When the second external device 60 does not remove from the cable 400, the procedure goes to block 518.

At block 526, the cable 400 detects whether the external storage 70 removes from the cable 400. When the external storage 70 removes from the cable 400, the procedure goes to block 507. When the external storage 70 does not remove from the cable 400, the procedure goes to block 527.

At block 527, the cable 400 detects whether the first external device 50 inserts into the cable 400. When the first external device 50 inserts into the cable 400, the procedure goes to block 533. When the first external device 50 does not insert into the cable 400, the procedure goes to block 528.

At block 528, the cable 400 detects whether the second external device 60 removes from the cable 400. When the second external device 60 removes from the cable 400, the procedure goes to block 505. When the second external device 60 does not remove from the cable 400, the procedure goes to block 519.

At block 529, the cable 400 in the first function establishes communication between the first external device 50 and the second external device 60. Meanwhile, the inserted external storage 70 is disabled. At present, the cable 400 are simultaneously connected with the first external device 50, the second external device 60, and the external storage 70.

At block 530, the cable 400 detects whether the external storage 70 removes from the cable 400. When the external storage 70 removes from the cable 400, the procedure goes to block 518. When the external storage 70 does not remove from the cable 400, the procedure goes to block 531.

At block 531, the cable 400 detects whether the first external device 50 removes from the cable 400. When the first external device 50 removes from the cable 400, the procedure goes to block 519. When the first external device 50 does not remove from the cable 400, the procedure goes to block 532.

At block 532, the cable 400 detects whether the second external device 60 removes from the cable 400. When the second external device 60 removes from the cable 400, the procedure goes to block 517. When the second external device 60 does not remove from the cable 400, the procedure goes to block 529.

At block 533, the cable 400 keeps in the current state and waits for a trigger. At present, the cable 400 is simultaneously connected with the first external device 50, the second external device 60, and the external storage 70.

At block 534, the cable 400 detects whether the trigger is generated. When the cable 400 detects the trigger, the procedure goes to block 529. When the cable 400 does not detect the trigger, the procedure goes to block 535. In at least one embodiment, the trigger can be a duration time, or a removal of the external storage 70, a command from device driver, or a mechanical switch (not shown in FIG. 4).

At block 535, the cable 400 detects whether the first external device 50 removes from the cable 400. When the first external device 50 removed from the cable 400, the procedure goes to block 519. When the first external device 50 does not remove from the cable 400, the procedure goes to block 536.

At block 536, the cable 400 detects whether the second external device 60 removes from the cable 400. When the second external device 60 removes from the cable 400, the procedure goes to block 517. When the second external device 60 does not remove from the cable 400, the procedure goes to block 533.

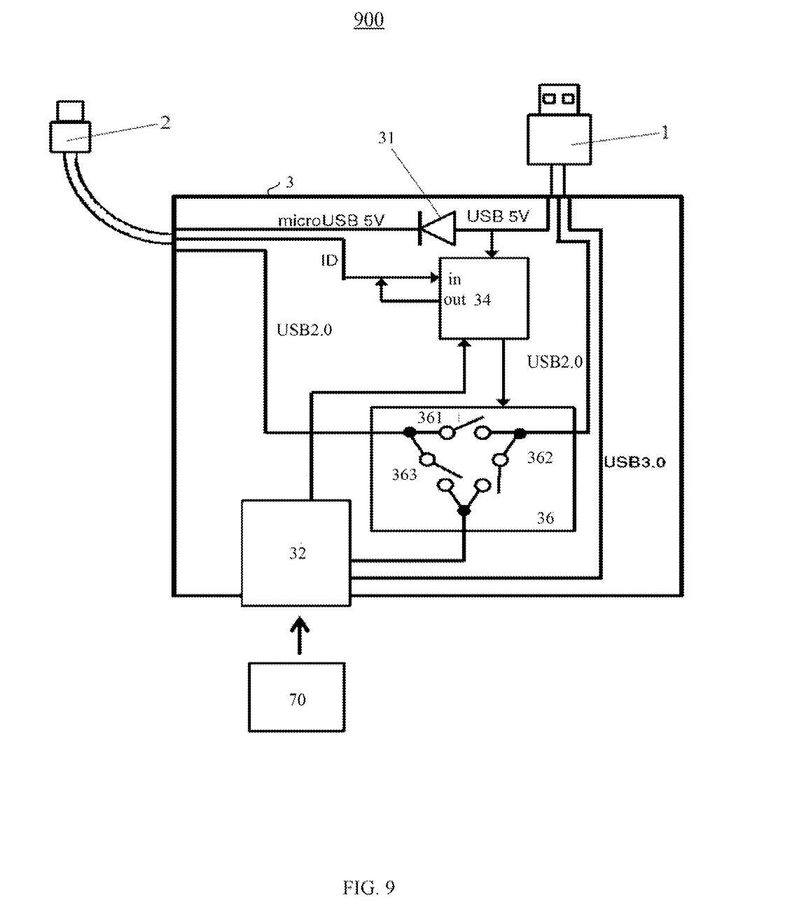

FIG. 9 illustrates a fifth embodiment of the cable 900. The difference between the cable 900 and the cable 400 is the first connector 1 and the storage unit 32.

The first connector 1 supports to USB3.0 standard, and the second connector 2, such as a microUSB2.0 connector, merely supports to USB2.0 standard. The controlling unit 34 further connects with the storage unit 32. The switching unit 36 is only required to support differential data signals (e.g. DP/DM data signals) under USB2.0 standard, from the first external device 50 and the second external device 60, and the storage unit 32 directly receives differential signals (e.g. SSTX/SSRX signals) under USB3.0 standard, from the first external device 50. In at least one embodiment, the first connector 1 in USB3.0 standard provides a faster data transmission and a wider bandwidth than that of the second connector 2 while the cable 900 is in the second function; when the first connector 1 and the second connector 2 are supported different standards, the cable 900 also can establishes a data transmission between the first connector 1 and the second connector 2 in USB2.0 standard.

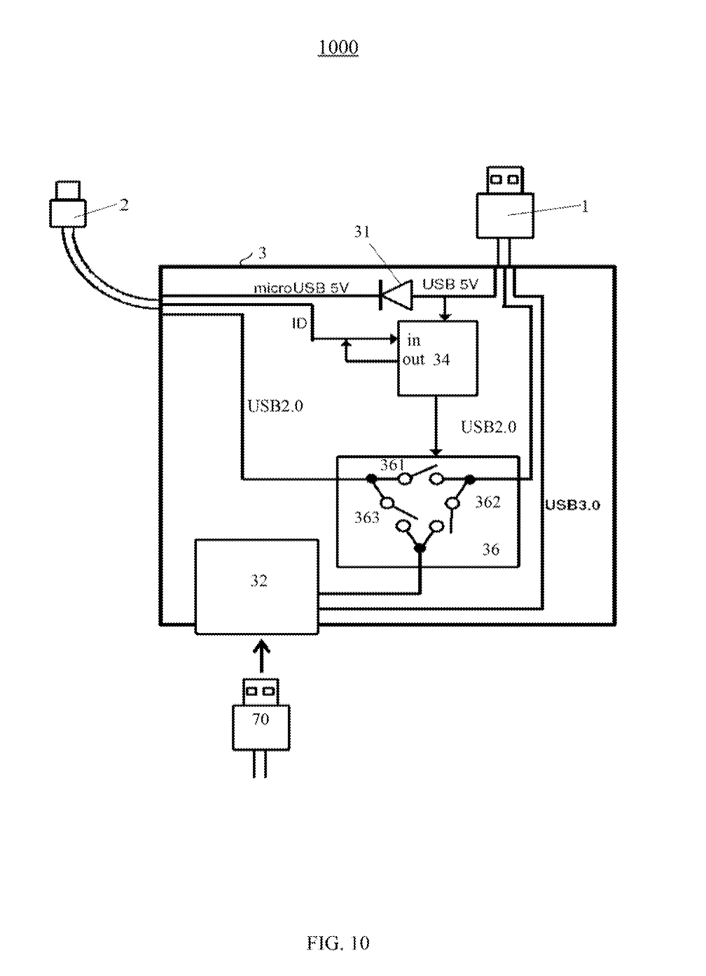

FIG. 10 illustrates a sixth embodiment of the cable 1000. The cable 1000 is similar to the cable 900, and also includes the first connector 1, the second connector 2 and the switching module 3. The difference between the cable 1000 and the cable 900 is the storage unit 32 and the controlling unit 34. The storage unit 32 is a USB connector for connecting a USB external device 70. In at least one embodiment, the USB external device 70 can be a storage device, a hub and other peripheral devices when the cable 1000 is in the second function or the third function.

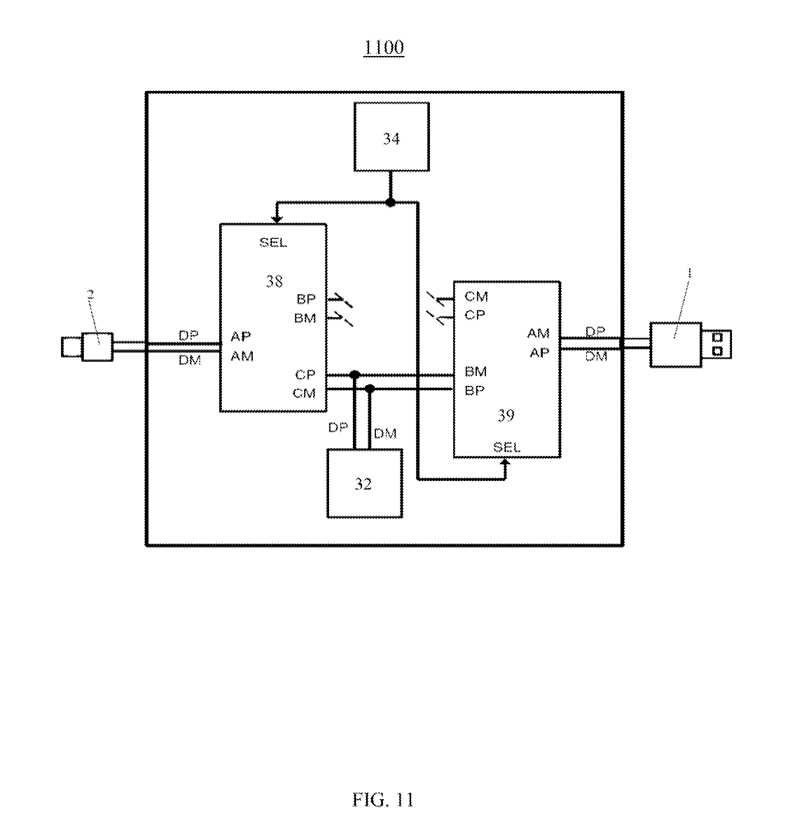

FIG. 11 illustrates a seventh embodiment of the cable 1100. The cable 900 employs a first selector 38 and a second selector 39 to act as a switching unit 36. That is, the switching unit 36 of the cable 900 includes the first selector 38 and the second selector 39. The first selector 38 is connected with the second connector 2, the controlling unit 34, the storage unit 32, and the second selector 39. The second selector 39 is connected with the first connector 1, the controlling unit 34, the storage unit 32, and the first selector 38. Each of the first selector 38 and the second selector 39 includes a selecting pin SEL, a pair of data inputting pins AM/AP, a pair of first outputting pins BP/BM and a pair of second outputting pins CP/CM. The inputting pins SEL of the first selector 38 and the second selector 39 are connected to an output terminal of the controlling unit 34 for receiving the controlling signals. The pair of data inputting pins AP/AM of the first selector 38 is connected to the data signals bus lines (e.g. the differential positive data (DP) signals and the differential minus data (DM) signals of the second connector 2. The pair of first outputting pins BP/BM of the first selector 38 and the pair of second outputting pins CP/CM of the second selector 39 are in a OPEN state. The pair of second outputting pins CP/CM of the first selector 38 is connected with the pair of first outputting pins BP/BM of the second selector 39, and further connects with the data signals bus lines of the storage unit 32. The pair of the data inputting pins AP/AM of the second selector 39 is connected with the data signals bus lines of the first connector 1. In the embodiment, the first selector 38 and the second selector 39 can be for example a multiplexer (MUX). The controlling signals denotes the first external device 50 connected with the first connector 1 or a second external device 60 connected with the second connector 2 serves as the host. In the embodiment, the controlling signal can be a logic low level signal for denoting the first external device 50 connected with the first connector 1 serves as the host, or a logic high level signal for denoting the second external device 60 connected with the second connector 2 serves as the host.

Table 4, below, shows the relationship between the controlling signal output by the controlling unit 34, the state of the first selector 38, the state of the second selector 39, and the function of the cable 900 for establishing communication.

TABLE 4

| Condition | Result | | |
|---|---|---|---|
| Controlling | State of the | State of the | Function of the |
| signal | first selector | second selector | cable |
| Logic low | AP\AM-BP\BM | AP\AM-BP\BM | USB-storage unit |
| Logic high | AP\AM-CP\CM | AP\AM-CP\CM | microUSB-storage |
| | | | unit |

When the controlling signal is a logic low level signal, the pair of the data inputting pins AP/AM of the first selector 38 is connected to the pair of the first outputting pins BM/BP of the first selector 38, and the pair of the data inputting pins AP/AM of the second selector 39 is connected to the pair of second outputting pins BP/BM of the second selector 39, thus the cable 1100 switches into the second function for establishing a communication between the first external device and the storage unit 32. When the controlling signal is a logic high level signal, the pair of data inputting pins AP/AM of the first selector 38 is connected to the pair of third outputting pin CP/CM of the first selector 38, and the pair of data inputting pins AP/AM of the second selector 39 is connected to the pair of the first outputting pins CM/CP of the second selector 39, thus the cable 1100 switches into the third function for establishing a communication between the second external device and the storage unit 32.

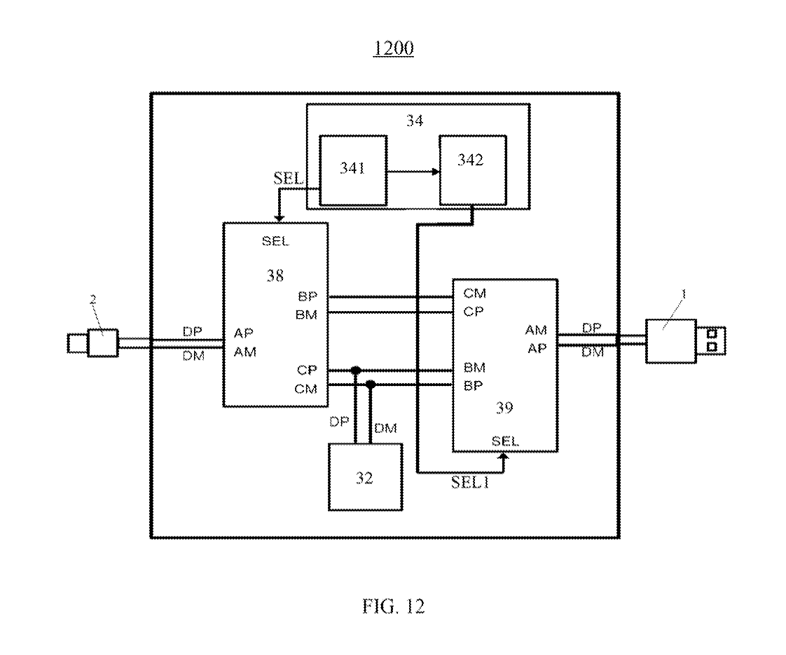

FIG. 12 illustrates an eighth embodiment of the cable 1200. The cable 1000 is similar to the cable 1100, and the difference between the cable 1200 and the cable 1100 is the first selector 38, the second selector 39, and the controlling unit 34. The pair of the first outputting pins BM/BP of the first selector 38 is further connected to the pair of the second outputting pins CM/CP of the second selector 39. The controlling unit 34 includes a first sub-controlling unit 341 and a second sub-controlling unit 342. The first sub-controlling unit 341 is capable of outputting a first selecting signal SEL to the second sub-controlling unit 342 and the first selector 38. When a first external device 50 is connected with the first connector 1, the first sub-controlling unit 341 outputs the first selecting signal SEL with the logic low level signal. When no first external device 50 is connected with the first connector 1, the first sub-controlling unit 341 outputs the first selecting signal SEL with the logic high level signal. The second sub-controlling unit 342 is connected to the first sub-controlling unit 341 and the second selector 39. The second sub-controlling unit 342 is capable of selectively outputting a second selecting signal SELL The second selecting signal SEL1 can be same with the first selecting signal SEL or different from the first selecting signal SEL. The second sub-controlling unit 342 outputs the second selecting signal SEL1 only under a condition that the first external device 50 acts as the host and the second external device 60 is connected with the second connector 2. Otherwise, the second sub-controlling unit 342 maintains to output the second selecting signal SEL1 which is same as the first selecting signal SEL. In the embodiment, the second selecting signal SEL1 is valid when being logic high level signal. In the embodiment, the controlling signals of the controlling unit 34 includes the first selecting signal SEL with the logic high level signal, the first selecting signal SEL with the logic low level signal and the second selecting signal SEL1, which corresponding the second, third and first controlling signals, respectively. In at least one embodiment, the second selecting signal SELL is valid when being logic high level signal. The controlling signals of the controlling unit 34 includes the first selecting signal SEL and the second selecting signal SEL1 in the logic high level signal, the first selecting signal SEL and the second selecting signal SEL1 in the logic low level signal, the first selecting signal SEL and the second selecting signal SEL1 in the logic high level signal, which corresponding the second, third and first controlling signals, respectively.

Table 5, below, shows the relationship between the first selecting signal SEL output by the first sub-controlling unit 341, the second selecting signal SEL1 output by the second sub-controlling unit 342, the state of the first selector 38, the state of the second selector 39, and the function of the cable 1000 for establishing a communication.

TABLE 5

| | | State of the | State of the | Function of the |
|---|---|---|---|---|
| SEL | SEL1 | first selector | second selector | cable |
| Logic | Equal to | AP\AM- | AP\AM- | microUSB-storage |
| high | SEL | CP\CM | CP\CM | unit |
| Logic | Equal to | AP\AM- | AP\AM- | USB-storage unit |
| low | SEL | BP\BM | BP\BM | |
| Logic | Logic high | AP\AM- | AP\AM- | USB-microUSB |
| low | | BP\BM | CP\CM | cable |

When the first selecting signal SEL and the second selecting signal SEL1 both are a logic high level signal, the pair of the data inputting pins AP/AM of the first selector 38 is connected to the pair of the second outputting pins CP/CM of the first selector 38, and the pair of the data inputting pins AP/AM of the second selector 39 is connected to the pair of the second outputting pins CP/CM of the second selector 39, thus the cable 1000 switches into the third function for establishing a communication between the second external device 60 and the storage unit 32. When the first selecting signal SEL and the second selecting signal SEL1 both are a logic low level signal, the pair of the data inputting pins AP/AM of the first selector 38 is connected to the pair of the first outputting pins BP/BM of the first selector 38, and the pair of the data inputting pins AP/AM of the second selector 39 is connected to the pair of the first outputting pins BP/BM of the second selector 39, thus the cable 1000 switches to the second function for establishing a communication between the first external device 50 and the storage unit 32. When the first selecting signal SEL is a logic low level signal and the second selecting signal SELL is a logic high level signal, the pair of the data inputting pins AP/AM of the first selector 38 is connected to the pair of the first outputting pins BP/BM of the first selector 38, and the data pair of the inputting pins AP/AM of the second selector 39 is connected to the pair of the second outputting pins CP/CM of the second selector 39, thus the cable 1000 switches into the first function for establishing a communication between the first external device 50 and the second external device 60.

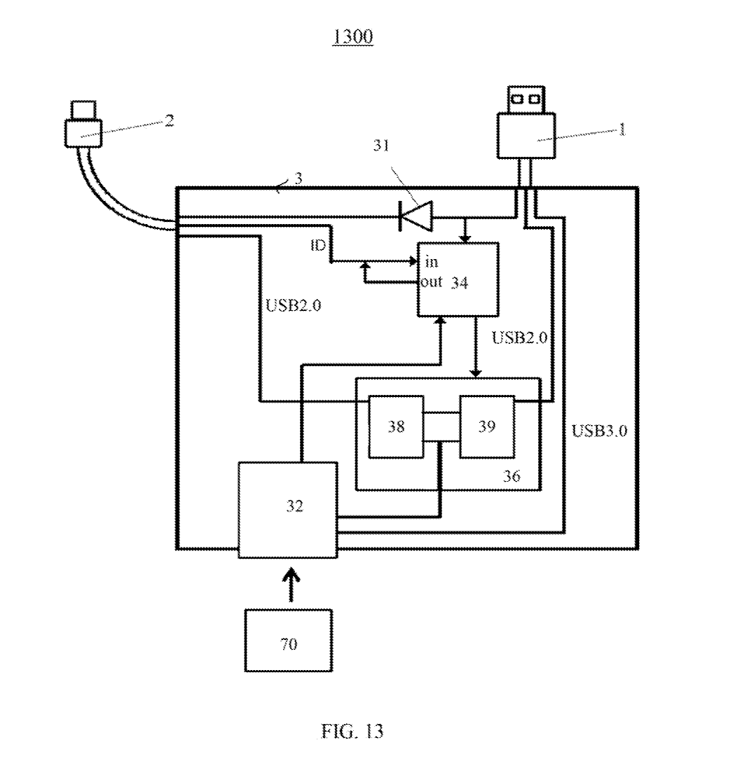

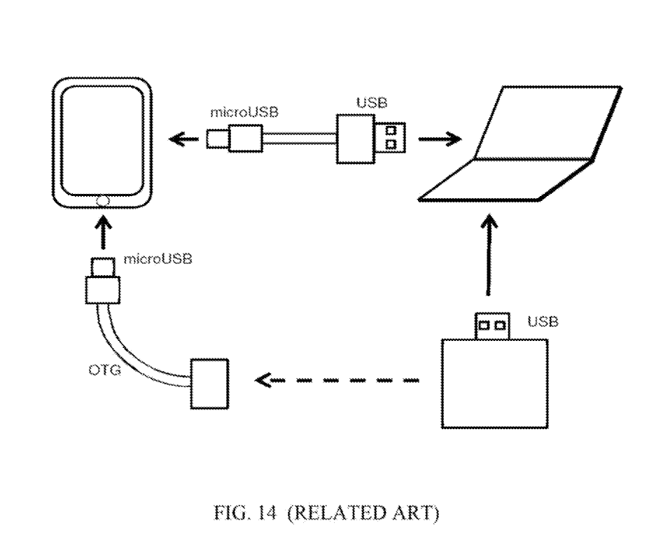

FIG. 13 illustrates a ninth embodiment of the cable 1300. The cable 1300 is similar to the cable 900, and the difference between the cable 1300 and the cable 900 is the switching unit 36. The controlling unit 34 generates different controlling signals based on the bus power from a first external device 50 connected with the first connector 1, the identification signal ID from the second external device 60 connected with the second connector 2, and the detecting signal generated by the storage unit 32.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including matters of shape, size, and arrangement of the parts within the principles of the present disclosure, up to and including the full extent established by the broad general meaning of the terms used in the claims.

What is claimed is:

1. A cable capable of switching between different functions for establishing different communications between the cable, a first external device, and a second external device, the cable comprising:
a first connector configured to connect with the first external device;
a second connector configured to connect with the second external device;
a controlling unit connected between the first connector and the second connector, and configured to generate different controlling signals based on a bus power from the first external device and an identification signal from the second external device;
a switching unit connected with the first connector, the second connector, and the controlling unit for establishing different connections in response to different controlling signals;
a rectification unit connected between the first connector and the second connector, and configured to ensure that a current direction is from the first external device to the second connector when the bus power is supplied by the first external device; and
a storage unit connected to the switching unit and configured to selectively communicate with one of the first external device and the second external device;
wherein when the switching unit establishes a communication between the first external device and the second external device, the cable switches into a first function; when the switching unit establishes a communication between the first external device and the storage unit, the cable switches into a second function; and when the switching unit establishes a communication between the second external device and the storage unit, the cable switches into a third function for transmitting data.

2. The cable of claim 1, wherein the controlling unit detects whether the first connector is connected with the first external device according to the bus power from the first external device, detects the second connector is connected with the second external device according to the identification signal, and determines which one of the first external device and the second external device acts as a host according to the bus power from the first external device and the identification signal from the second external device.

3. The cable of claim 2, wherein when the first external device acts as the host and the second external device is connected with the second connector, the controlling unit outputs a first controlling signal to the switching unit, the switching unit switches the cable into the first function according to the first controlling signal.

4. The cable of claim 2, wherein when the first external device acts as the host and the second external device is disconnected with the second connector, the controlling unit outputs a second controlling signal to the switching unit, and the switching unit switches the cable into the second function according the second controlling signal.

5. The cable of claim 2, wherein when the second external device acts as the host, the controlling unit outputs a third controlling signal to the switching unit, and the switching unit switches the cable into the third function according the third controlling signal.

6. The cable of claim 1, wherein the controlling unit comprises an input pin for receiving the identification signal and an output pin; the controlling unit generates different controlling signal based on the identification signal received by the input pin; the output pin is connected between the second connector and the input pin; the output pin is capable of switching between a GND state and an OPEN state; when receiving the bus power from the first connector, the controlling unit sets the output pin in the OPEN state, the controlling unit determines that the first external device acts as the host;.

7. The cable of claim 6, wherein when there is no the bus power from the first connector, the controlling unit sets the output pin in the GND state for outputting a logic low level signal; the input pin is set in GND state by the output of the output pin, the controlling signal determines that the second external device acts the host.

8. The cable of claim 1, further comprising a manual-operation switch connected between the second connector and the controlling unit, wherein the controlling unit comprises an input pin for receiving identification signal; the manual-operation switch manually switches between a first switching mode and a second switching mode to set states of the input pin, in the first switching mode, the manual-operation switch sets the input pin in the OPEN state, and in the second switching mode, the manual-operation switch sets the input pin in the GND state.

9. The cable of claim 8, wherein the output pin OUT of the controlling unit 34 can be a mechanical relay switch for outputting GND state without the bus power from the first external device

10. The cable of claim 8, wherein the storage unit is capable of connecting with an external storage; when the storage unit connects with the external storage, the storage unit generates a detecting signal to the controlling unit; the controlling unit generates the controlling signals based on the bus power from the first external device, the switching modes of the manual-operation switch, and the detecting signal.

11. The cable of claim 10, wherein the storage unit comprises a memory card slot, and the external storage is a portable memory card.

12. The cable of claim 1, wherein the switching unit includes a first switch, a second switch, and a third switch; the first switch is connected between the first connector and the second connector, the second switch is connected between the first connector and the storage unit, the third switch is connected between the second connector and the storage unit, the first switch turns on for establishing the communication between the first external device and the second external device; the second switch turns on for establishing the communication between the first external device and the cable; the third switch turns on for establishing the communication between the second external device and the cable.

13. The cable of claim 1, wherein the storage unit is capable of connecting with an external storage; when the storage unit connects with the external storage, the storage unit generates a detecting signal to the controlling unit; the controlling unit generates the controlling signals based on the bus power from the first external device, the identification signal from the second external device, and the detecting signal.

14. The cable of claim 13, wherein the storage unit comprises a memory card slot, and the external storage is a portable memory card.

15. The cable of claim 1, wherein when the first connector in USB3.0 standard provides a faster data transmission and a wider bandwidth than the second connector while the cable is in the second function; when the first connector and the second connector are respectively supported different standards, the cable can directly establishes a data transmission between the first connector and the second connector.

16. The cable of claim 1, wherein the storage unit is replaced by a connector, and the storage unit is equivalent to the first connector or the second connector.

17. The cable of claim 1, wherein the switching unit comprises a first selector and a second selector, the first selector is connected between the second connector and the second selector, the second selector is connected to the first connector and the first selector; the controlling unit simultaneously outputs the controlling signal to the first selector and the second selector.

18. The cable of claim 17, wherein each of the first and second selectors comprises a selecting pin, a pair of inputting data pins, a pair of first outputting pins and a pair of second outputting pins, the pair of the first outputting pins of the first selector are connected to the pair of the second outputting pins of the second selector, the pair of data inputting pins of the first selector are connected to the second connector, the pair of second outputting pins of the first selector connect with the pair of first outputting pins of the second selector, and further connect with the storage unit, the pair of the data inputting pins are connected with the first connector, and the controlling unit selectively outputs a first selecting signal and a second selecting signal as the controlling signals to the selecting pins of the first selector and the second selector.

19. The cable of claim 18, wherein the controlling unit comprises a first sub-controlling unit and a second sub-controlling unit, the first sub-controlling unit is configured to output a first selecting signal to the second sub-controlling unit and the first selector, the second sub-controlling unit is connected to the first sub-controlling unit and the second selector, and the second sub-controlling unit outputs the second selecting signal only under a condition that the first external device acts as the host and the second external device is connected with the second connector, otherwise the second sub-controlling unit maintains to output the second selecting signal which is same as the first selecting signal.

20. The cable of claim 1, wherein the switching unit comprises a first selector and a second selector, the first selector is connected between the second connector and the second selector, the second selector is connected to the first connector and the first selector, and the first selector and the second selector switches the cable between the second function and the third function based on the controlling signals from the controlling unit.

21. The cable of claim 20, wherein each of the first and second selectors comprises a selecting pin, a pair of inputting data pins, a pair of first outputting pins and a pair of second outputting pins, the selecting pins of the first and second selectors connect with a same outputting terminal of the control unit, the pair of first outputting pins of the first selector and the pair of second outputting pins are floating, the pair of second outputting pins of the first selector are connected with the pair of first outputting pins of the second selector, and further connect with the storage unit, the pair of the data inputting pins are connected with the first connector.
